(19) United States
(12) Patent Application Publication
(10) Pub. No.: US 2021/0049371 A1
(43) Pub. Date: Feb. 18, 2021

(54) LOCALISATION, MAPPING AND NETWORK TRAINING

(71) Applicant: University of Essex Enterprises Limited, Colchester, Essex (GB)

(72) Inventors: Dongbing GU, Colchester (GB); Ruihao Li, Colchester (GB)

(21) Appl. No.: 16/978,434

(22) PCT Filed: Mar. 18, 2019
(86) PCT No.: PCT/GB2019/050755

§ 371 Date: Sep. 4, 2020

(30) Foreign Application Priority Data
Mar. 20, 2018 (GB) 1804400.8

(51) Int. Cl. G06K 9/00; G06T 7/60; G06N 3/04; G06N 3/08

(52) U.S. Cl. CPC G06K 9/00791; G06T 7/60; G06N 3/0454; G06T 2207/10012; G06T 2207/20084; G06T 2207/20081; G06N 3/088

(57) ABSTRACT

Methods, systems and apparatus are disclosed. A method of simultaneous localisation and mapping of a target environment responsive to a sequence of mono images of the target environment comprises providing the sequence of mono images to a first and a further neural network, wherein the first and further neural networks are unsupervised neural networks pretrained using a sequence of stereo image pairs and one or more loss functions defining geometric properties of the stereo image pairs providing the sequence of mono images into a still further neural network, wherein the still further neural network is pretrained to detect loop closures and providing simultaneous localisation and mapping of the target environment responsive to an output of the first, further and still further neural networks.

The present invention relates to a system and method for simultaneous localisation and mapping (SLAM) in a target environment. In particular, but not exclusively, the present invention relates to use of pretrained unsupervised neural networks that can provide for SLAM using a sequence of mono images of the target environment.

Visual SLAM techniques use a sequence of images of an environment, typically obtained from a camera, to generate a 3-dimensional depth representation of the environment and to determine a pose of a current viewpoint. Visual SLAM techniques are used extensively in applications such as robotics, vehicle autonomy, virtual/augmented reality (VR/AR) and mapping where an agent such as a robot or vehicle moves within an environment. The environment can be a real or virtual environment.

Developing accurate and reliable visual SLAM techniques has been the focus of much effort in the robotics and computer vision communities. Many conventional visual SLAM systems use model based techniques. These techniques work by identifying changes in corresponding features in sequential images and inputting the changes into mathematical models to determine depth and pose.

While some model based techniques have shown potential in visual SLAM applications, the accuracy and reliability of these techniques can suffer in challenging conditions such as when encountering low light levels, high contrast and unfamiliar environments. Model based techniques are also not capable of changing or improving their performance over time.

Recent work has shown that deep learning algorithms known as artificial neural networks may address some of the problems of certain existing techniques. Artificial neural networks are trainable brain-like models made up of layers of connected “neurons”. Depending on how they are trained, artificial neural networks may be classified as supervised or unsupervised.

Recent work has demonstrated that supervised neural networks may be useful in visual SLAM systems. However, a major disadvantage of supervised neural networks is that they have to be trained using labelled data. In visual SLAM systems, such labelled data typically consists of one or more sequences of images for which depth and pose is already known. Generating such data is often difficult and expensive. In practice this often means supervised neural networks have to be trained using smaller amounts of data and this can reduce their accuracy and reliability, particularly in challenging or unfamiliar conditions.

Other work has demonstrated unsupervised neural networks may be used in computer vision applications. One of the benefits of unsupervised neural networks is that they can be trained using unlabelled data. This eliminates the problem of generating labelled training data and means that often these neural networks can be trained using larger data sets. However, to date in computer vision applications unsupervised neural networks have been limited to visual odometry (rather than SLAM) and have been unable to reduce or eliminate accumulated drift. This has been a significant barrier to their wider use.

It is an aim of the present invention to at least partly mitigate the above-mentioned problems.

It is an aim of certain embodiments of the present invention to provide simultaneous localisation and mapping of a target environment using a sequence of mono images of the target environment.

It is an aim of certain embodiments of the present invention to provide a pose and depth estimate for a scene whereby the pose and depth estimate are accurate and reliable even in challenging or unfamiliar environments.

It is an aim of certain embodiments of the present invention to provide simultaneous localisation and mapping using one or more unsupervised neural networks whereby the one or more unsupervised neural networks are pre-trained using unlabelled data.

It is an aim of certain embodiments of the present invention to provide a method of training a deep-learning based SLAM system using unlabelled data.

According to a first aspect of the present invention there is provided a method of simultaneous localisation and mapping of a target environment responsive to a sequence of mono images of the target environment, the method comprising: providing the sequence of mono images to a first and a further neural network, wherein the first and further neural networks are unsupervised neural networks pretrained using a sequence of stereo image pairs and one or more loss functions defining geometric properties of the stereo image pairs; providing the sequence of mono images into a still further neural network, wherein the still further neural network is pretrained to detect loop closures; and providing simultaneous localisation and mapping of the target environment responsive to an output of the first, further and still further neural networks.

Aptly the method further comprises the one or more loss functions include spatial constraints defining a relationship between corresponding features of the stereo image pairs, and temporal constraints defining a relationship between corresponding features of sequential images of the sequence of stereo image pairs.

Aptly the method further comprises each of the first and further neural networks are pretrained by inputting batches of three or more stereo image pairs into the first and further neural networks.

Aptly the method of further comprises the first neural network provides a depth representation of the target environment and the further neural network provides a pose representation within the target environment.

Aptly the method further comprises the further neural network provides an uncertainty measurement associated with the pose representation.

Aptly the method further comprises the first neural network is a neural network of an encoder-decoder type.

Aptly the method further comprises the further neural network is a neural network of a recurrent convolutional neural network including long short term memory type.

Aptly the method further comprises the still further neural network provides a sparse feature representation of the target environment.

Aptly the method further comprises the still further neural network is a neural network of a ResNet based DNN type.

Aptly the step of providing simultaneous localisation and mapping of the target environment responsive to an output of the first, further and still further neural networks further comprises: providing a pose output responsive to an output from the further neural network and an output from the still further neural network.

Aptly the method further comprises providing said a pose output based on local and global pose connections.

Aptly the method further comprises responsive to said a pose output, using a pose graph optimiser to provide a refined pose output.

According to a second aspect of the present invention there is provided a system for providing simultaneous localisation and mapping of a target environment responsive to a sequence of mono images of the target environment, the system comprising: a first neural network; a further neural network; and a still further neural network; wherein: the first and further neural networks are unsupervised neural networks pretrained using a sequence of stereo image pairs and one or more loss functions defining geometric properties of the stereo image pairs, and wherein the still further neural network is pretrained to detect loop closures.

Aptly the system further comprises: the one or more loss functions include spatial constraints defining a relationship between corresponding features of the stereo image pairs, and temporal constraints defining a relationship between corresponding features of sequential images of the sequence of stereo image pairs.

Aptly the system further comprises each of the first and further neural networks are pretrained by inputting batches of three or more stereo image pairs into the first and further neural networks.

Aptly the system further comprises the first neural network provides a depth representation of the target environment and the further neural network provides a pose representation within the target environment.

Aptly the system further comprises the further neural network provides an uncertainty measurement associated with the pose representation.

Aptly the system further comprises each image pair of the sequence of stereo image pairs comprises a first image of a training environment and a further image of the training environment, said further image having a predetermined offset with respect to the first image, and said first and further images having been captured substantially simultaneously.

Aptly the system further comprises the first neural network is a neural network of an encoder-decoder type neural network.

Aptly the system further comprises the further neural network is a neural network of a recurrent convolutional neural network including long short term memory type.

Aptly the system further comprises the still further neural network provides a sparse feature representation of the target environment.

Aptly the system further comprises the still further neural network is a neural network of a ResNet based DNN type

According to a third aspect of the present invention there is provided a method of training one or more unsupervised neural networks for providing simultaneous localisation and mapping of a target environment responsive to a sequence of mono images of the target environment, the method comprising: providing a sequence of stereo image pairs; providing a first and a further neural network, wherein the first and further neural networks are unsupervised neural networks associated with one or more loss functions defining geometric properties of the stereo image pairs; and providing the sequence of stereo image pairs to the first and further neural networks.

Aptly the method further comprises the first and further neural networks are trained by inputting batches of three or more stereo image pairs into the first and further neural networks.

Aptly the method further comprises each image pair of the sequence of stereo image pairs comprises a first image of a training environment and a further image of the training environment, said further image having a predetermined offset with respect to the first image, and said first and further images having been captured substantially simultaneously.

According to a fourth aspect of the present invention there is provided a computer program comprising instructions which, when the program is executed by a computer, cause the computer to carry out the method of the first or third aspect.

According to a fifth aspect of the present invention there is provided a computer-readable medium comprising instructions which, when executed by a computer, cause the computer to carry out the method of the first or third aspect.

According to a sixth aspect of the present invention there is provided a system for providing simultaneous localisation and mapping of a target environment responsive to a sequence of mono images of the target environment, the system comprising: a first neural network; a further neural network; and a loop closure detector; wherein: the first and further neural networks are unsupervised neural networks pretrained using a sequence of stereo image pairs and one or more loss functions defining geometric properties of the stereo image pairs.

According to a seventh aspect of the present invention there is provided a vehicle comprising the system of the second aspect.

Aptly the vehicle is a motor vehicle, railed vehicle, watercraft, aircraft, drone or spacecraft.

According to an eighth aspect of the present invention there is provided an apparatus for providing virtual and/or augmented reality comprising the system of the second aspect.

According to a further aspect of the present invention there is provided a monocular visual SLAM system that utilises an unsupervised deep learning method.

According to a still further aspect of the present invention there is provide an unsupervised deep learning architecture for estimating pose and depth and optionally a point cloud based on image data captured by monocular cameras.

Certain embodiments of the present invention provide for simultaneous localisation and mapping of a target environment utilising mono images.

Certain embodiments of the present invention provide a methodology for training one or more neural networks that can subsequently be used for simultaneous localisation and mapping of an agent within a target environment.

Certain embodiments of the present invention enable parameters of a map of a target environment, together with a pose of an agent within that environment, to be inferred.

Certain embodiments of the present invention enable topological maps to be created as a representation of an environment.

Certain embodiments of the present invention use unsupervised deep learning techniques to estimate pose, depth map and 3D point cloud.

Certain embodiments of the present invention do not require labelled training data meaning training data is easy to collect.

Certain embodiments of the present invention utilise scaling on an estimated pose and depth determined from monocular image sequences. In this way an absolute scale is learned during a training stage mode of operation.

Certain embodiments of the present invention detect loop closures. If a loop closure is detected a pose graph can be constructed and a graph optimisation algorithm can be run. This helps reduce accumulated drift in pose estimation and can help improve estimation accuracy when combined with unsupervised deep learning methods.

Certain embodiments of the present invention utilise unsupervised deep learning to train networks. Consequently unlabelled data sets, rather than labelled data sets, can be used that are easier to collect.

Certain embodiments of the present invention simultaneously estimate pose, depth and a point cloud. In certain embodiments this can be produced for each input image.

Certain embodiments of the present invention can perform robustly in challenging scenes. For example when being forced to use distorted images and/or some images with excessive exposure and/or some images collected at night or during rainfall.

Certain embodiments of the present invention will now be described hereinafter, by way of example only, with reference to the accompanying drawings in which:

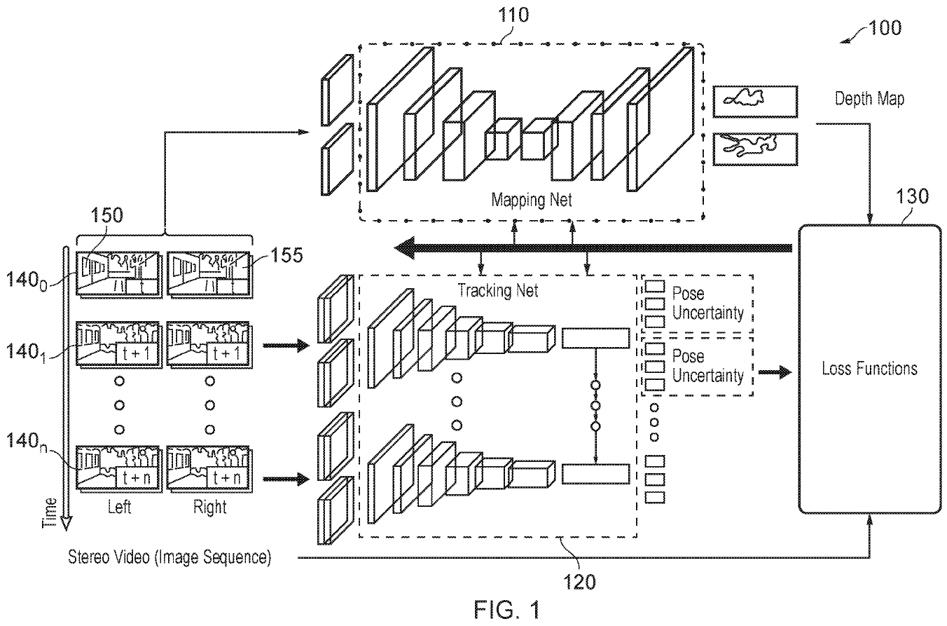

FIG. 1 illustrates a training system and a method of training a first and at least one further neural network;

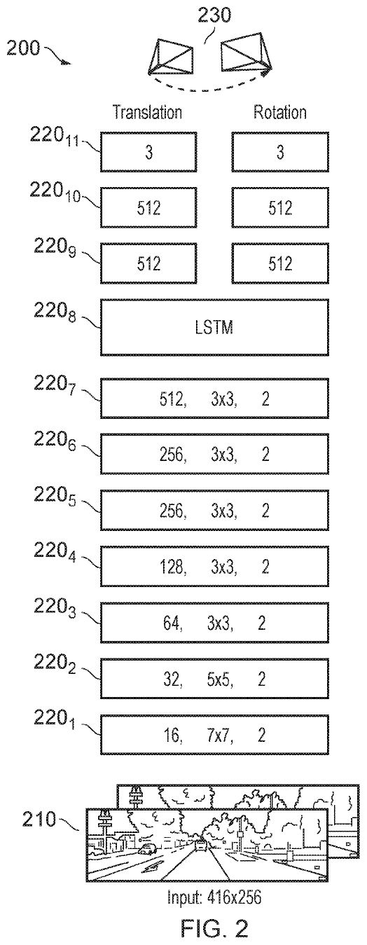

FIG. 2 provides a schematic diagram showing a configuration of a first neural network;

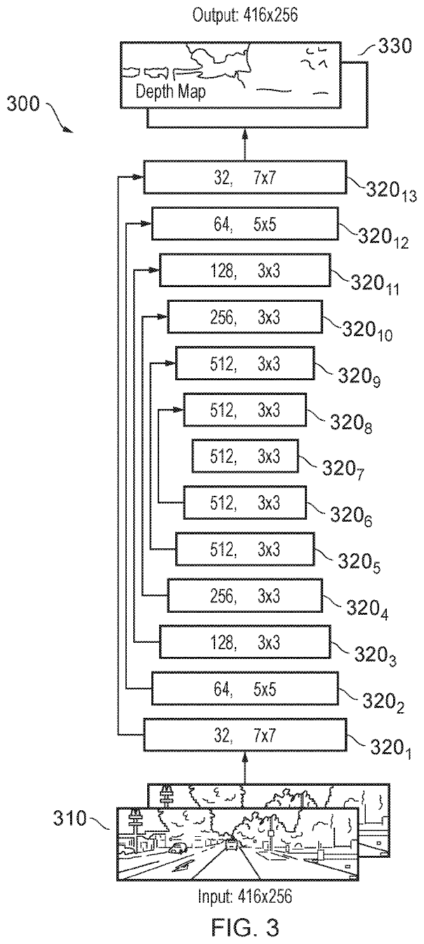

FIG. 3 provides a schematic diagram showing a configuration of a further neural network;

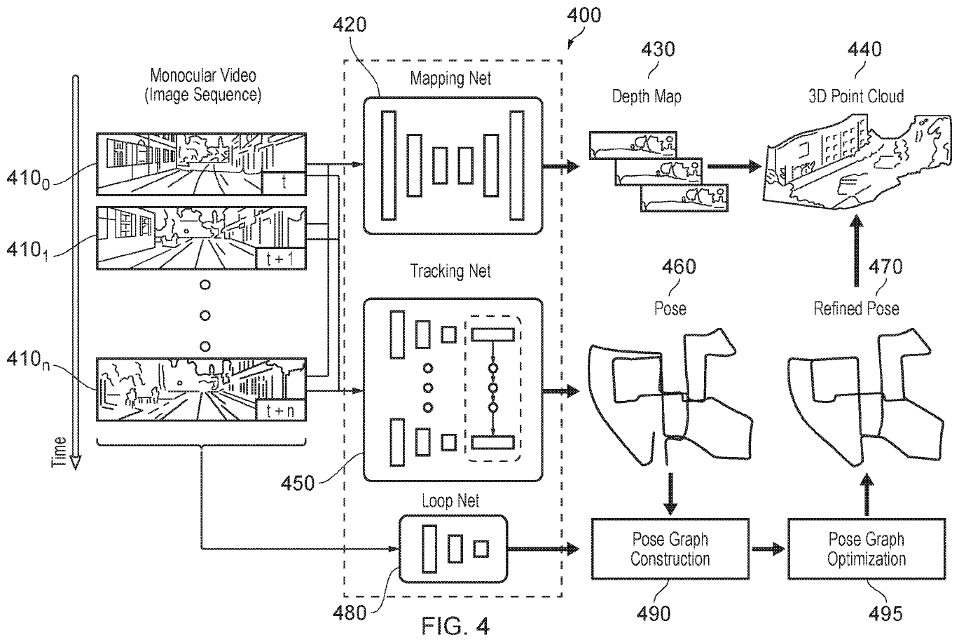

FIG. 4 provides a schematic diagram showing a system and method for providing simultaneous localisation and mapping of a target environment responsive to a sequence of mono images of the target environment; and

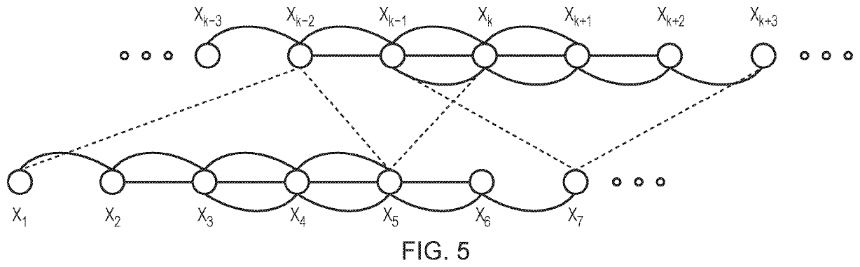

FIG. 5 provides a schematic diagram showing a pose graph construction technique.

In the drawings like reference numerals refer to like parts.

FIG. 1 provides an illustration of a training system and methodology of training a first and further unsupervised neural network. Such unsupervised neural networks can be utilised as part of a system for localisation and mapping of an agent, such as a robot or vehicle, in a target environment. As shown in FIG. 1, the training system 100 includes a first unsupervised neural network 110 and a further unsupervised neural network 120. The first unsupervised neural network may be referred to herein as the mapping-net 110 and the further unsupervised neural network may be referred to herein as the tracking-net 120.

As will be described in more detail below, after training the mapping-net 110 and tracking-net 120 may be used to help provide simultaneous localisation and mapping of a target environment responsive to a sequence of mono images of the target environment. The mapping-net 110 may provide a depth representation (depth) of the target environment and the tracking-net 120 may provide a pose representation (pose) within the target environment.

The depth representation provided by the mapping-net 110 may be a representation of the physical structure of the target environment. The depth representation may be provided as an output from the mapping-net 110 as an array having the same proportions as the input images. In this way each element in the array will correspond with a pixel in the input image. Each element in the array may include a numerical value that represents a distance to a nearest physical structure.

The pose representation may be a representation of the current position and orientation of a viewpoint. This may be provided as a six degrees of freedom (6DOF) representation of position/orientation. In a cartesian coordinate system, the 6DOF pose representation may correspond to an indication of position along an x, y, and z axis and rotation around the x, y and z axis. The pose representation can be used to construct a pose map (pose graph) showing the motion of the viewpoint over time.

Both the pose and depth representations may be provided as absolute (rather than relative) values i.e. as values that correspond to real world physical dimensions.

The tracking-net 120 may also provide an uncertainty measurement associated with the pose representation. This may be a statistical value representing the estimated accuracy of the pose representation output from the tracking-net.

The training system and methodology of training also includes one or more loss functions 130. The loss functions are used to train the mapping-net 110 and tracking-net 120 using unlabelled training data. The loss functions 130 are provided with the unlabelled training data and use this to calculate the expected outputs of the mapping-net 110 and tracking-net 120 (i.e. depth and pose). During training the actual outputs of the mapping-net 110 and tracking-net 120 are continuously compared with their expected outputs and the current error is calculated. The current error is then used to train the mapping-net 110 and tracking-net 120 by a process known as backpropagation. This process involves trying to minimise the current error by adjusting trainable parameters of the mapping-net 110 and tracking-net 120. Such techniques for adjusting parameters to reduce the error may involve one or more processes known in the art such as gradient descent.

As will be described in more detail herein below, during training a sequence of stereo image pairs 140_{0,1 . . . n} is provided to the mapping-net and tracking-net. The sequence may comprise batches of three or more stereo image pairs. The sequence may be of a training environment. The sequence may be obtained from a stereo camera moving through a training environment. In other embodiments, the sequence may be of a virtual training environment. The images may be colour images.

Each stereo image pair of the sequence of stereo image pairs may comprise a first image 150_{0,1 . . . n} of a training environment and a further image of 155_{0,1 . . . n} of the training environment. A first stereo image pair is provided that is associated with an initial time t. A next image pair is provided for t+1 where 1 indicates a preset time interval. The further image may have a predetermined offset with respect to the first image. The first and further images may have been captured substantially simultaneously i.e. at substantially the same point in time. For the system training scheme shown in FIG. 1 the input to the mapping-net and tracking-net are thus stereo image sequences represented as left image sequence (I_{l, t+n, . . . ,} I_{l, t+1,} I_{l, t}) and right image sequence (I_{r, t+n, . . . ,} I_{r, t+1,} I_{r, t}) at current time step t. At each time step, a pair of new images is added to the beginning of the input sequence and the last pair is removed from the input sequence. The size of the input sequence is kept constant. The purpose of using stereo image sequences instead of monocular ones for training is to recover the absolute scale of pose and depth estimation.

The loss functions 130 shown in FIG. 1 are used to train the mapping-net 110 and tracking-net 120 via a backpropagation process as described herein. The loss functions include information about the geometric properties of stereo image pairs of the particular sequence of stereo image pairs that will be used during training. In this way the loss functions include geometric information that is specific to the sequence of images that will be used during training. For example, if the sequence of stereo images is generated by a particular stereo camera setup, the loss functions will include information related to the geometry of that setup. This means the loss functions can extract information about the physical environment from stereo training images. Aptly the loss functions may include spatial loss functions and temporal loss functions.

The spatial loss functions (also referred to herein as spatial constraints) may define a relationship between corresponding features of stereo image pairs of the sequence of stereo image pairs that will be used during training. The spatial loss functions may represent the geometric projective constraint between corresponding points in left-right image pairs.

The spatial loss functions may themselves include three subset loss functions. These will be referred to as the spatial photometric consistency loss function, the disparity consistency loss function and the pose consistency loss function.

1. Spatial Photometric Consistency Loss Function

For a pair 140 of stereo images, each overlapping pixel i in one image has a corresponding pixel in the other image. To synthesize the left image l′ₗ from the original right image Iᵣ, every overlapped pixel i in image Iᵣ should find its correspondence in image Iₗ with a horizontal distance Hᵢ. Given its estimated depth value \hat{D}ᵢ from the mapping-net, the distance Hᵢ can be calculated by

$${H}_{i} = \frac{B f}{{\hat{D}}_{i}}$$

where B is the baseline of stereo camera and f is the focal length.

Based on a calculated Hᵢ, I′ₗ can be synthesized by warping image Iₗ from image Iᵣ through a spatial transformer. The same process can be applied to synthesize the right image I′ᵣ.

Assume I′ₗ and I′ᵣ are the synthesized left and right images from original right image Iᵣ and left image Iₗ, respectively. The spatial photometric consistency loss functions are defined as

L_{l,r}^{p}=Σλₛfₛ(Iₗ, I′ₗ)+(1−λₛ)∥Iₗ−I′ₗ∥₁

L_{r,l}^{p}=Σλₛfₛ(Iᵣ, I′ᵣ)+(1−λₛ)∥Iᵣ−I′ᵣ∥₁

where λₛ is a weight, ∥·∥₁ is the L1 norm, fₛ(·)=(1−SSIM(·))/2 and SSIM(·) is the Structural SIMilarity (SSIM) metric to evaluate the quality of a synthesized image.

2. Disparity Consistency Loss Function

A disparity map can be defined by

Q=H×W

where W is the image width.

Assume Qₗ and Qᵣ are the left and right disparity maps. The disparity maps are computed from estimated depth maps. Q′ₗ and Q′ᵣ can be synthesized from Qᵣ and Qₗ, respectively. The disparity consistency loss functions are defined as

L_{l,r}^{d}=Σ∥Qₗ−Q′ₗ∥

L_{r,l}^{d}=Σ∥Qᵣ−Q′ᵣ∥

3. Pose Consistency Loss Function

If left and right image sequences are used to separately estimate the six degrees of freedom transformations using the tracking net, it may be desirable for these relative transformations to be exactly the same. The differences between these two groups of pose estimates can be introduced as a left-right pose consistency loss. Assume (\hat{x}ₗ, \hat{φ}ₗ) and (\hat{x}ᵣ, \hat{φ}ᵣ) are the estimated poses from left and right image sequences by the tracking-net and λₚ and λᵣ are translation and rotation weights. The difference between these two estimates is defined as the pose consistency loss:

L⁰=λₚ∥\hat{x}ₗ−\hat{x}ᵣ∥+λᵣ∥\hat{φ}ₗ−\hat{φ}ᵣ∥

The temporal loss functions (also referred to herein as temporal constraints) define a relationship between corresponding features of sequential images of the sequence of stereo image pairs that will be used during training. In this way the temporal loss functions represent the geometric projective constraint between corresponding points in two consecutive monocular images.

The temporal loss functions may themselves include two subset loss functions. These will be referred to as the temporal photometric consistency loss function and the 3D geometric registration loss function.

1. Temporal Photometric Consistency Loss Functions

Assume Iₖ and Iₖ₊₁ are two images at time k and k+1. I′ₖ and I′ₖ₊₁ are synthesized from Iₖ₊₁ and Iₖ, respectively. The photometric error maps are Eₚ^{k}=Iₖ−I′ₖ and Eₚ^{k+1}=Iₖ₊₁−I′ₖ₊₁. The temporal photometric loss functions are defined as

L_{k,k+1}^{p}=ΣMₚ^{k}(λₛfₛ(Iₖ, I′ₖ)+(1−λₛ)∥Eₚ^{k}∥₁)

L_{k+1,k}^{p}=ΣMₚ^{k+1}(λₛfₛ(Iₖ₊₁, I′ₖ₊₁)+(1−λₛ)∥Eₚ^{k+1}∥₁)

where Mₚ^{k} and Mₚ^{k+1} are the masks of the corresponding photometric error maps.

The image synthesis process is preceded by using geometric models and spatial transformer. To synthesize image I′ₖ from image Iₖ₊₁, every overlapped pixel pₖ in image Iₖ should find its correspondence p′ₖ₊₁ in image Iₖ₊₁ by

p′ₖ₊₁=K\hat{T}_{k,k+1}\hat{D}ₖK⁻¹pₖ

where K is the known camera intrinsic matrix, \hat{D}ₖ is the pixel's depth estimated from the Mapping-Net, \hat{T}_{k,k+1} is the camera coordinate transformation matrix from image Iₖ to image Iₖ₊₁ estimated by the Tracking-Net. Based on this equation, I′ₖ is synthesized by warping image Iₖ from image Iₖ₊₁ through a spatial transformer.

The same process can be applied to synthesize image I′ₖ₊₁.

2. 3D Geometric Registration Loss Function

Assuming Pₖ and Pₖ₊₁ are two 3D point clouds at time k and k+1. P′ₖ and P′ₖ₊₁ are synthesized from Pₖ₊₁ and Pₖ, respectively. The geometric error maps are E_{g}^{k}=Pₖ−P′ₖ and E_{g}^{k+1}=Pₖ₊₁−P′ₖ₊₁. The 3D geometric registration loss functions are defined as

L_{k,k+1}^{p}=ΣM_{g}^{k}∥E_{g}^{k}∥₁

L_{k+1,k}^{p}=ΣM_{g}^{k+1}∥E_{g}^{k+1}∥₁

where M_{g}^{k} and M_{g}^{k+1} are the masks of the corresponding geometric error maps.

As described above, the temporal image loss functions use masks Mₚ^{k}, Mₚ^{k+1}, M_{g}^{k}, M_{g}^{k+1}. The masks are used to remove or reduce the presence of moving objects in images and thereby reduce one of the main error sources for visual SLAM techniques. The masks are computed from the estimated uncertainty of the pose which is output from the tracking-net. This process is described in more detail below.

### Uncertainty Loss Function

The photometric error maps Eₚ^{k}, Eₚ^{k+1} and the geometric error maps E_{g}^{k} and E_{g}^{k+1} are computed from the original images Iₖ, Iₖ₊₁and estimated point clouds Pₖ, Pₖ₊₁. Assume μₚ^{k}, μₚ^{k+1}, μ_{g}^{k}, μ_{g}^{k+1} are the mean of Eₚ^{k}, Eₚ^{k+1}, E_{g}^{k}, E_{g}^{k+1} respectively. The uncertainty of pose estimation is defined as

σ_{k,k+1}=2S(μₚ^{k}+μₚ^{k+1}+λₑ(μ_{g}^{k}+μ_{g}^{k+1}))−1

where S(·) is the Sigmoid function and λₑ is the normalizing factor between the geometric and photometric errors. Sigmoid is the function normalizing the uncertainty between 0 and 1 to represent the belief on the accuracy of pose estimate.

The uncertainty loss function is defined as

L_{k,k+1}^{μ}=∥σ_{k,k+1}−\hat{σ}_{k,k+1}∥₁

\hat{σ}_{k,k+1} represents the uncertainties of estimated poses and depth maps. \hat{σ}_{k,k+1} is small when the estimated pose and depth maps are accurate enough to reduce the photometric and geometric errors. \hat{σ}_{k,k+1} is estimated by the tracking-net which is trained with σ_{k,k+1}.

### Masks

Moving objects in a scene can be problematic in SLAM systems since they do not provide reliable information about the underlying physical structure of the scene for depth and pose estimation. As such it is desirable to remove as much as possible of this noise. In certain embodiments, noisy pixels of an image may be removed prior to the image entering the neural networks. This may be achieved using masks as described herein.

In addition to providing a pose representation, the further neural network may provide an estimated uncertainty. When the estimated uncertainty value is high, the pose representation will typically have lower accuracy.

The outputs of tracking-net and mapping-net are used to compute the error maps based on the geometric properties of the stereo image pairs and temporal constraints of the sequence of stereo image pairs. An error map is an array where each element in the array corresponds to a pixel of input image.

A mask map is an array of values “1” or “0”. Each element corresponds to a pixel of input image. When the value of an element is “0”, the corresponding pixel in the input image should be removed because value “0” represents a noise pixel. Noise pixels are the pixels related to moving objects in the image, which should be removed from the image so that only static features are used for estimation.

The estimated uncertainty and error maps are used construct the mask map. The value of an element in mask map is “0” when the corresponding pixel has large estimated error and high estimated uncertainty. Otherwise its value is “1”.

When an input image arrives, it is filtered by using the mask map first. After this filter step, the remaining pixels in the input image is used as the input to the neural networks.

The masks are constructed with a percentile qₜₕ of pixels as 1 and a percentile (100−qₜₕ) of pixels as 0. Based on the uncertainty σ_{k,k+1}, the percentile qₜₕ of the pixels is determined by

qₜₕ=q₀+(100−q₀)(1−σ_{k,k+1})

where q₀ ∈ (0,100) is the basic constant percentile. The masks Mₚ^{k}, Mₚ^{k+1},M_{g}^{k}, M_{g}^{k+1} are computed by filtering out (100−qₜₕ) of the big errors (as outliers) in the corresponding error maps. The generated masks not only automatically adapt to the different percentage of outliers, but also can be used to infer dynamic objects in the scene.

In certain embodiments the tracking-net and mapping-net are implemented with the TensorFlow framework and trained on a NVIDIA DGX-1 with Tesla P100 architecture. The GPU memory required may be less than 400 MB with 40 Hz real-time performance. An Adam optimizer may be used to train the tracking-net and mapping-net for up to 20-30 epochs. The starting learning rate is 0.001 and decreased by half for every ⅕ of total iterations. The parameter β_1 is 0.9 and β_1 is 0.99. The sequence length of images feeding to the tracking-net is 5. The image size is 416 by 128.

The training data may be the KITTI dataset, which includes 11 stereo video sequences. The public RobotCar dataset may also be used for training the networks.

FIG. 2 shows the tracking-net 200 architecture in more detail in accordance with certain embodiments of the present invention. As described herein, the tracking-net 200 may be trained using a stereo sequence of images and after training may be used for providing SLAM responsive to a sequence of mono images.

The tracking-net 200 may be a recurrent convolutional neural network (RCNN). The recurrent convolutional neural network may comprise a convolutional neural network and a long short term memory (LSTM) architecture. The convolutional neural network part of the network may be used for feature extraction and the LSTM part of the network may be used for learning the temporal dynamics between consecutive images. The convolutional neural network may be based on an open source architecture such as the VGGnet architecture available from the University of Oxford's Visual Geometry Group.

The tracking-net 200 may include multiple layers. In the example architecture depicted in FIG. 2, the tracking-net 200 includes 11 layers (220₁₋₁₁) although it will be appreciated that other architectures and numbers of layers could be used.

The first 7 layers are convolutional layers. As shown in FIG. 2, each convolution layer includes a number of filters of a certain size. The filters are used to extract features from images as they move through the layers of the network. The first layer (220₁) includes 16 7×7 pixel filters for each pair of input images. The second layer (220₂) includes 32 5×5 pixel filters. The third layer (220₃) includes 64 3×3 pixel filters. The fourth layer (220₄) includes 128 3×3 pixel filters. The fifth (220₅) and sixth (220₆) layers each include 256 3×3 pixel filters. The seventh layer (220₇) includes 512 3×3 pixel filters.

After the convolutional layers there is a long short term memory layer. In the example architecture illustrated in FIG. 2 this layer is the eighth layer (220₈). The LSTM layer is used to learn the temporal dynamics between consecutive images. In this way the LSTM layer can learn based on information contained in several consecutive images. The LSTM layer may include an input gate, forget gate, memory gate and output gate.

After the long short term memory layer there are three fully connected layers (220₉₋₁₁). As shown in FIG. 2, separate fully connected layers may be provided for estimating rotation and translation. It has been found that this arrangement can improve the accuracy of pose estimation since rotation has a higher degree of non-linearity than translation. Separating the estimation of rotation and translation can allow normalisation of the respective weights given to rotation and translation. The first and second fully connected layers (220_{9,10}) include 512 neurons and the third fully connected layer (220₁₁) includes 6 neurons. The third fully connected layer outputs a 6 DOF pose representation (230). If the rotation and translation have been separated, this pose representation may be output as a 3 DOF translational and 3 DOF rotational pose representation. The tracking-net may also output an uncertainty associated with the pose representation.

During training the tracking-net is provided with a sequence of stereo image pairs (210). The images may be colour images. The sequence may comprise batches of stereo image pairs, for example batches of 3, 4, 5 or more stereo image pairs. In the example shown each image has a resolution of 416×256 pixels. The images are provided to the first layer and move through the subsequent layers until a 6 DOF pose representation is provided from final layer. As described herein, the 6 DOF pose output from the tracking-net is compared with the 6 DOF pose calculated by the loss functions and the mapping net is trained to minimise this error via backpropagation. The training process may involve modifying weightings and filters of the tracking-net to try to minimise the error in accordance with techniques known in the art.

During use, the trained tracking-net is provided with a sequence of mono images. The sequence of mono images may be obtained in real time from a visual camera. The mono images are provided to the first layer of the network and move through the subsequent layers of the network until a final 6 DOF pose representation is provided.

FIG. 3 shows the mapping-net 300 architecture in more detail in accordance with certain embodiments of the present invention. As described herein, the mapping-net 300 may be trained using a stereo sequence of images and after training may be used for providing SLAM responsive to a sequence of mono images.

The mapping-net 300 may be an encoder-decoder (or autoencoder) type architecture. The mapping-net 300 may include multiple layers. In the example architecture depicted in FIG. 3, the mapping-net 300 includes 13 layers (320₁₋₁₃) although it will be appreciated that other architectures could be used.

The first 7 layers of the mapping-net 300 are convolution layers. As shown in FIG. 3, each convolution layer includes a number of filters of a certain pixel size. The filters are used to extract features from images as they move through the layers of the network. The first layer (320₁) includes 32 7×7 pixel filters. The second layer (320₂) includes 64 5×5 pixel filters. The third layer (320₃) includes 128 3×3 pixel filters. The fourth layer (320₄) includes 256 3×3 pixel filters. The fifth (320₅), sixth (320₆) and seventh (320₇) layers each include 512 3×3 pixel filters.

After the convolutional layers there are 6 de-convolution layers. In the example architecture of FIG. 3 the de-convolution layers comprise the eighth to thirteenth layers (320₈₋₁₃).

Similar to the convolution layers described above, each de-convolution layer includes a number of filters of a certain pixel size. The eighth (320₈) and ninth (320₉) layers include 512 3×3 pixel filters. The tenth layer (320₁₀) includes 256 3×3 filters. The eleventh layer (320₁₁) includes 128 3×3 pixel filters. The twelfth layer (320₁₂) includes 64 5×5 filters. The thirteenth layer (320₁₃) includes 32 7×7 pixel filters.

The final layer (320₁₃) of the mapping-net 300 outputs a depth map (depth representation) 330. This may be a dense depth map. The depth map may correspond in size with the input images. The depth map provides a direct (rather than inverse or disparity) depth map. It has been found that providing a direct depth map can improve training by improving the convergence of the system during training. The depth map provides an absolute measurement of depth.

During training the mapping-net 300 is provided with a sequence of stereo image pairs (310). The images may be colour images. The sequence may comprise batches of stereo image pairs, for example batches of 3, 4, 5 or more stereo image pairs. In the example shown each image has a resolution of 416×256 pixels. The images are provided to the first layer and move through the subsequent layers until a final depth representation is provided from the final layer. As described herein, depth output from the mapping-net is compared with the depth calculated by the loss functions in order to identify the error (spatial losses) and the mapping-net is trained to minimise this error via backpropagation. The training process may involve modifying weightings and filters of the mapping-net to try to minimise the error.

During use, the trained mapping-net is provided with a sequence of mono images. The sequence of mono images may be obtained in real time from a visual camera. The mono images are provided to the first layer of the network and move through the subsequent layers of the network until a depth representation is output from the final layer.

FIG. 4 shows a system 400 and method for providing simultaneous localisation and mapping of a target environment responsive to a sequence of mono images of the target environment. The system may be provided as part of a vehicle such as a motor vehicle, railed vehicle, watercraft, aircraft, drone or spacecraft. The system may include a forward facing camera which provides a sequence of mono images to the system. In other embodiments the system may be a system for providing virtual reality and/or augmented reality.

The system 400 includes mapping-net 420 and tracking-net 450. The mapping-net 420 and tracking-net 450 may be configured and pretrained as described herein with reference to FIGS. 1 to 3. The mapping-net and tracking-net may operate as described with reference to FIGS. 1 to 3 except in that the mapping-net and tracking-net are provided with a sequence of mono images rather than a sequence of stereo images and the mapping-net and tracking-net do not need to be associated with any loss functions.

The system 400 also includes a still further neural network 480. The still further neural network may be referred to herein as the loop-net.

Returning to the system and method depicted in FIG. 4, during use a sequence of mono images of a target environment (410₀, 410₁, 410ₙ) is provided to the pretrained mapping-net 420, tracking-net 450 and loop-net 480. The images may be colour images. The sequence of images may be obtained in real time from a visual camera. The sequence of images may alternatively be a video recording. In either case each of the images may be separated by a regular time interval.

The mapping-net 420 uses the sequence of mono images to provide a depth representation 430 of the target environment. As described herein, the depth representation 430 may be provided as a depth map that corresponds in size with the input images and represents the absolute distance to each point in the depth map.

The tracking-net 450 uses the sequence of mono images to provide a pose representation 460. As described herein, the pose representation 460 may be a 6 DOF representation. The cumulative pose representations may be used to construct a pose map. The pose map may be output from the tracking-net may and may provide relative (or local) rather than global pose consistency. The pose map output from the tracking-net may therefore include accumulated drift.

The loop-net 480 is a neural network that has been pretrained to detect loop closures. Loop closure may refer to identifying when features of a current image in a sequence of images correspond at least partially to features of a previous image. In practice, a certain degree of correspondence between features of a current image and a previous image typically suggests that an agent performing SLAM has returned to a location that it has already encountered. When a loop closure is detected, the pose map can be adjusted to eliminate any offset that has accumulated as described below. Loop closure can therefore help to provide an accurate measure of pose with global rather than just local consistency.

In certain embodiments, the loop-net 480 may be an Inception-Res-Net V2 architecture. This is an open-source architecture with pre-trained weighting parameters. The input may be an image with the size of 416 by 256 pixels.

The loop-net 480 may calculate a feature vector for each input image. Loop closures may then be detected by computing the similarity between the feature vectors of two images. This may be referred to as the distance between vector pairs and may be calculated as the cosine distance between two vectors as

d_{cos}=cos(v₁,v₂)

where v₁,v₂ are the feature vectors of two images. When d_{cos} is smaller than a threshold, a loop closure is detected and the two corresponding nodes are connected by a global connection.

Detecting loop closures using a neural network based approach is beneficial because the entire system can be made to be no longer reliant on geometric model based techniques.

As shown in FIG. 4, the system may also include a pose graph construction algorithm and a pose graph optimization algorithm. The pose graph construction algorithm is used to construct a globally consistent pose graph by reducing the accumulated drift. The pose graph optimization algorithm is used to further refine the pose graph output from the pose graph construction algorithm.

The operation of the pose graph construction algorithm is illustrated in more detail in FIG. 5. As shown, pose graph construction algorithm consists of a sequence of nodes (X₁, X₂, X₃, X₄, X₅, X₆, X₇ . . . , Xₖ₋₃, Xₖ₋₂, Xₖ₋₁, Xₖ, Xₖ₊₁, Xₖ₊₂, Xₖ₊₃ . . . ) and their connections. Each node corresponds to a particular pose. The solid lines represent local connections and the dashed lines represent global connections. The local connections indicate that two poses are consecutive. In other words, that the two poses correspond with images that were captured at adjacent points in time. The global connections indicate a loop closure. As described above, a loop closure is typically detected when there is more than a threshold similarity between the features of two images (indicated by their feature vectors). The pose graph construction algorithm provides a pose output responsive to an output from the further neural network and the still further neural network. The output may be based on local and global pose connections.

Once the pose graph has been constructed, a pose graph optimization algorithm (pose graph optimiser) 495 may be used to improve the accuracy of the pose map by fine tuning the pose estimates and further reducing any accumulated drift. The pose graph optimization algorithm 495 is shown schematically in FIG. 4. The pose graph optimization algorithm may be an open source framework for optimizing graph-based nonlinear error functions such as the “g2o” framework. The pose graph optimization algorithm may provide a refined pose output 470.

While the pose graph construction algorithm 490 is shown in FIG. 4 as a separate module, in certain embodiments the functionality of the pose graph construction algorithm may be provided by the loop-net.

The pose graph output from the pose graph construction algorithm or the refined pose graph output from the pose graph optimization algorithm may combined with the depth map output from the mapping-net to produce a 3D point cloud 440. The 3D point cloud may comprise a set of points representing their estimated 3D coordinates. Each point may also have associated color information. In certain embodiments this functionality may be used to produce a 3D point cloud from a video sequence.

During use the data requirements and time of computation are much less than those during training. No GPU is required.

Compared with a training mode, in a use mode the system may have significantly lower memory and computational demands. The system may operate on a computer without a GPU. A laptop equipped with NVIDIA GeForce GTX 980M and Intel Core i7 2.7 GHz CPU may be used.

It is important to note an advantage provided by the above described visual SLAM techniques in accordance with certain embodiments of the present invention compared with other computer vision techniques such as visual odometry.

Visual odometry techniques attempt to identify the current pose of a viewpoint by combining the estimated motion between each of the preceding frames. However visual odometry techniques have no way of detecting loop closures which means they cannot reduce or eliminate accumulated drift. This also means that even small errors in estimated motion between frames can accumulate and lead to large scale inaccuracies in the estimated pose. This makes such techniques problematic in applications where accurate and absolute pose orientation is desired, such as in autonomous vehicles and robotics, mapping, VR/AR.

In contrast, visual SLAM techniques according to certain embodiments of the present invention include steps to reduce or eliminate accumulated drift and to provide an updated pose graph. This can improve the reliability and accuracy of SLAM. Aptly visual SLAM techniques according to certain embodiments of the present invention provide an absolute measure of depth.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of simultaneous localisation and mapping of a target environment responsive to a sequence of mono images of the target environment, the method comprising:
providing the sequence of mono images to a first and a second neural network, wherein the first and second neural networks are unsupervised neural networks pretrained using a sequence of stereo image pairs and one or more loss functions defining geometric properties of the stereo image pairs;
providing the sequence of mono images into a third neural network, wherein the third neural network is pretrained to detect loop closures; and
providing simultaneous localisation and mapping of the target environment responsive to an output of the first, second and third neural networks.

2. The method of claim 1, wherein:
the one or more loss functions include spatial constraints defining a relationship between corresponding features of the stereo image pairs, and temporal constraints defining a relationship between corresponding features of sequential images of the sequence of stereo image pairs.

3. The method of claim 1, wherein:
each of the first and second neural networks are pretrained by inputting batches of three or more stereo image pairs into the first and second neural networks.

4. The method of claim 1, wherein:
the first neural network provides a depth representation of the target environment and the second neural network provides a pose representation within the target environment.

5. The method of claim 4, wherein:
the second neural network provides an uncertainty measurement associated with the pose representation.

6. (canceled)

7. (canceled)

8. The method of claim 1, wherein:
the third network provides a sparse feature representation of the target environment.

9. (canceled)

10. The method of claim 1, wherein:
providing simultaneous localisation and mapping of the target environment responsive to an output of the first, second and third neural networks further comprises:
providing a pose output responsive to an output from the second neural network and an output from the third neural network.

11. (canceled)

12. (canceled)

13. A system for providing simultaneous localisation and mapping of a target environment responsive to a sequence of mono images of the target environment, the system comprising:
a first neural network;
a second neural network; and
a third neural network; wherein:
the first and second neural networks are unsupervised neural networks pretrained using a sequence of stereo image pairs and one or more loss functions defining geometric properties of the stereo image pairs, and wherein the third neural network is pretrained to detect loop closures.

14. The system of claim 13, wherein:
the one or more loss functions include spatial constraints defining a relationship between corresponding features of the stereo image pairs, and temporal constraints defining a relationship between corresponding features of sequential images of the sequence of stereo image pairs.

15. The system of claim 13, wherein:
each of the first and second neural networks are pretrained by inputting batches of three or more stereo image pairs into the first and second neural networks.

16. The system of claim 13, wherein:
the first neural network is configured to provides a depth representation of the target environment and the second neural network is configured to provide a pose representation within the target environment.

17. (canceled)

18. The system of claim 13, wherein:
each image pair of the sequence of stereo image pairs comprises a first image of a training environment and a further image of the training environment, said further image having a predetermined offset with respect to the first image, and said first and further images having been captured substantially simultaneously.

19. (canceled)

20. (canceled)

21. The system of claim 13, wherein:
the third neural network is configured to provide a sparse feature representation of the target environment.

22. (canceled)

23. A method of training one or more unsupervised neural networks for providing simultaneous localisation and mapping of a target environment responsive to a sequence of mono images of the target environment, the method comprising:
providing a sequence of stereo image pairs;
providing a first and a second neural network, wherein the first and second neural networks are unsupervised neural networks associated with one or more loss functions defining geometric properties of the stereo image pairs; and
providing the sequence of stereo image pairs to the first and second neural networks.

24. The method of claim 23, wherein:
the first and second neural networks are trained by inputting batches of three or more stereo image pairs into the first and second neural networks.

25. The method of claim 23, wherein:
each image pair of the sequence of stereo image pairs comprises a first image of a training environment and a further image of the training environment, said further image having a predetermined offset with respect to the first image, and said first and further images having been captured substantially simultaneously.

26. (canceled)

27. A computer-readable medium comprising instructions which, when executed by a computer, cause the computer to carry out the method of claim 1.

28. (canceled)

29. A vehicle comprising the system of claim 13, wherein the vehicle comprises a motor vehicle, railed vehicle, watercraft, aircraft, drone or spacecraft.

30. (canceled)

31. (canceled)

32. A computer-readable medium comprising instructions which, when executed by a computer, cause the computer to carry out the method of claim 23.
